(19) United States
(12) Patent Application Publication
(10) Pub. No.: US 2018/0336280 A1
(43) Pub. Date: Nov. 22, 2018

(54) CUSTOMIZED SEARCH BASED ON USER AND TEAM ACTIVITIES

(71) Applicant: LinkedIn Corporation, Sunnyvale, CA (US)

(72) Inventors: Tony Yin, Millbrae, CA (US); Songtao Guo, Cupertino, CA (US)

(21) Appl. No.: 15/597,396

(22) Filed: May 17, 2017

(51) Int. Cl. G06F 17/30; G06Q 50/00; G06Q 10/06; G06N 99/00

(52) U.S. Cl. CPC G06F 17/30867; G06Q 50/01; G06F 17/30477; G06N 99/005; G06F 17/30401; G06Q 10/06315; G06F 17/30554

(57) ABSTRACT

Methods, systems, and computer programs are presented for searching a database of learning modules to provide recommendations based on user and team data. One method includes an operation for detecting a search query for a training module for a user. The search query is detected in an area associated with a team in a social network, and the user is part of the team. Further, the method includes an operation for expanding the search query with information about the user and with information about the team. Additionally, the method includes an operation for executing the expanded search query to search for training modules in a database of training modules. In addition, the method includes an operation for presenting the results from executing the expanded search query, wherein the results are presented in the social network to the user.

### TECHNICAL FIELD

The subject matter disclosed herein generally relates to methods, systems, and programs for improving search results and, more particularly, methods, systems, and computer programs for improving search results based on data added to a search query.

### BACKGROUND

When a user wants to learn about a subject, the user may perform a search for training materials. However, there are many sites where learning materials are available, and many kinds of search materials. Further, some of the learning materials may be free, or require a fee, or the quality of the materials may be difficult to appraise before actually accessing the training materials.

Existing search methodologies tend to ignore the abilities and profiles of the user, as well as the user environment, such as the company where a user works or the work team of the user.

### BRIEF DESCRIPTION OF THE DRAWINGS

Various ones of the appended drawings merely illustrate example embodiments of the present disclosure and cannot be considered as limiting its scope.

FIG. 1 is a user interface for team communications with an option to search for training modules, according to some example embodiments.

FIG. 2 is a block diagram illustrating a networked system, according to some example embodiments.

FIG. 3 illustrates a method for recommending training materials, according to some example embodiments.

FIG. 4 illustrates data structures for storing user and team information, according to some example embodiments.

FIG. 5 illustrates the training and use of a machine-learning program, according to some example embodiments.

FIG. 6 illustrates the three-dimensional aspect of searching for training modules, according to some example embodiments.

FIG. 7 is a simplified schematic diagram of a computer system for implementing embodiments described herein.

FIG. 8 is a flowchart of a method, according to some example embodiments, for searching a database of learning modules to provide recommendations based on user and team data.

FIG. 9 is a block diagram illustrating an example of a software architecture that may be installed on a machine, according to some example embodiments.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed for searching a database of learning modules to provide recommendations based on user and team data. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

When trying to determine the best training materials for the members of the team at the company, previous solutions are based on performing periodic searches on known learning websites, having a person sort the training materials available and estimate their volume, and then provide recommendations to the team. For example, the recommendations may include a video lesson with the name of the teacher, the length of the video, and the subject matter. This process is cumbersome, slow, and requires someone to perform the search and sort.

Some social networks provide features for team collaboration, such as chat rooms, shared databases, messaging facilities, etc. Embodiments presented here leverage the information available in the social networks to find training materials that are easier to find and leverage the team knowledge available in the social network. For example, when searching for training materials, the search application takes into account the training materials that other members of the team have consumed, the ratings on the training materials by the team members and other members of the social network, and social activities.

For example, the social network may detect when a team is discussing a technical issue within a chat room and then provide suggestions for available training materials related to the topic of discussion. Further, an integrated command line input option is available to allow the user to request searches directly from the social network, without the user having to change environments and perform searches in an Internet browser, or some other learning application. Further, natural language processing is provided so users may ask questions in plain English regarding available training materials. Further, training applications may be integrated within the social network in order to enhance the usability of the social network and provide easy access to training materials.

One general aspect includes a method including having an operation for detecting, by one or more processors, a search query for a training module for a user. The search query is detected in an area associated with a team in a social network, where the user is part of the team. The method further includes an operation for expanding, by the one or more processors, the search query with information about the user and with information about the team. The method further includes executing, by the one or more processors, the expanded search query to search for training modules in a database of training modules. Additionally, the method includes causing, by the one or more processors, presentation of results from executing the expanded search query, the results being presented in the social network to the user.

One general aspect includes a system including a memory including instructions and one or more computer processors. The instructions, when executed by the one or more computer processors, cause the one or more computer processors to perform operations including: detecting a search query for a training module for a user, the search query being detected in an area associated with a team in a social network, the user being part of the team; expanding the search query with information about the user and with information about the team; executing the expanded search query to search for training modules in a database of training modules; and causing presentation of results from executing the expanded search query, the results being presented in the social network to the user.

One general aspect includes a non-transitory machine-readable storage medium including instructions that, when executed by a machine, cause the machine to perform operations including: detecting a search query for a training module for a user, the search query being detected in an area associated with a team in a social network, the user being part of the team; expanding the search query with information about the user and with information about the team; executing the expanded search query to search for training modules in a database of training modules; and causing presentation of results from executing the expanded search query, the results being presented in the social network to the user.

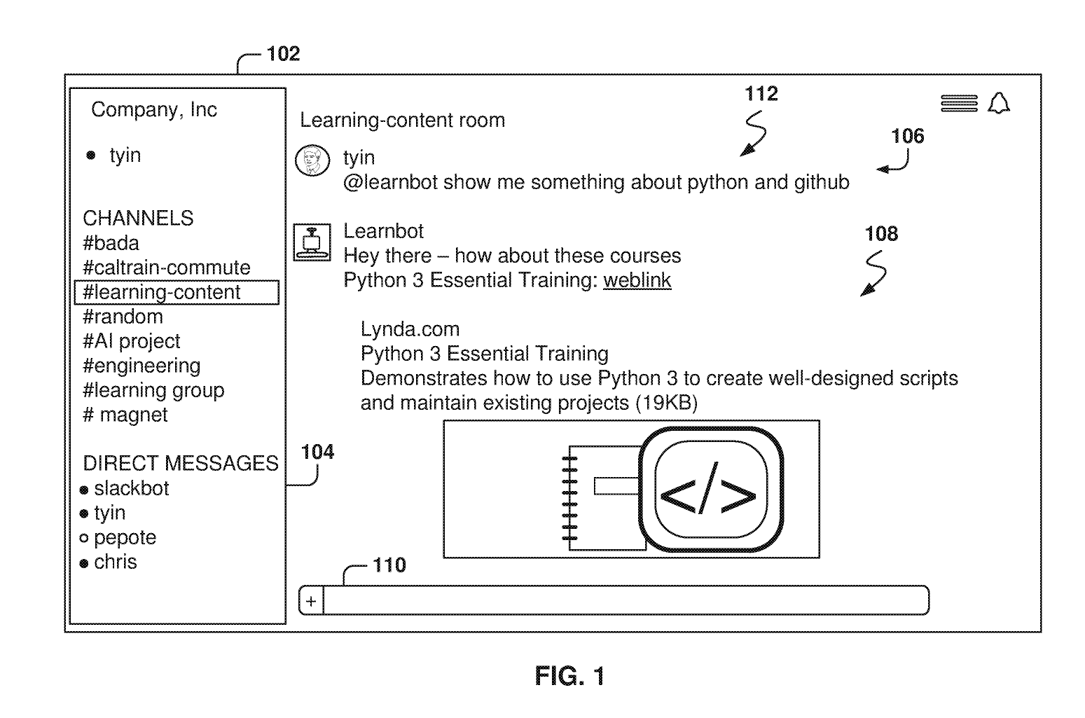

FIG. 1 is a user interface 102 for team communications with an option to search for training modules, according to some example embodiments. The user interface 102 includes a left panel 104 and a chat interface 112. The left panel 104 includes social network information, such as the name of the company (e.g., “Company, Inc.”) hosting a part of the social network reserved for company employees, user name or user login (e.g., “tyin”), channels that the user is subscribed to, and an option for direct messaging with other users. In the example embodiment of FIG. 1, the channel currently being used is highlighted in some fashion, such as encased on a box, presented in a bold font or bigger font, presented in a different color, etc.

As used herein, each channel is a chat room where members of the team may exchange messages, files, videos, photos, etc. Typically, each channel is associated with a topic of interest to the team, such as scheduling, project information, updates, etc. In some example embodiments, a team may define a plurality of channels, and it is up to the user to subscribe to some of the channels or all of the channels. Further, the user may belong to several teams and subscribe to channels from each of the teams, and the user interface 102 shows the channels available to the user for all the teams. In other example embodiments, the user interface provides an option to select a team and present only the channels associated with that team.

The chat interface 112 includes a space for showing the messages entered by the users in that channel, such as message 106 and message 108. The chat interface 112 further includes an input field 110 for entering messages. In some example embodiments, other input options may be available, such as options to attach files, enter web links, add a photo, etc.

In some example embodiments, a special tag is defined to invoke a learning application, also referred to herein as a “learnbot,” and when this special tag is entered and followed by additional text, the additional text is passed to the learning application for initiating a search for training materials, or some other command.

In some example embodiments, the search query may be entered in plain English and natural language processing is performed by the learning application to interpret the request. In the example illustrated in FIG. 1, the user has entered, in message 106, “@learnbot show me something about python and github.” The learning application processes the request and interprets that the request is for training materials related to python and github.

The learning application responds with message 108 having suggestions for some courses (only the first one is shown in the figure), with the first recommendation being for a course offered by Linda.com and titled, “Python 3 Essential Training,” a description of the course, and some additional information.

In some example embodiments, the learning application considers not only the terms entered by the user, but also the context of the user. The context of the user may include information from the user profile, information about the user's team, information about activities of the team in the social network, etc. This way, the search query is enhanced by considering the additional information, which results in better results for the user.

For example, if the team is discussing in a chat room a Windows implementation, the learning application will consider this and add “Windows” to the query, so training materials related to a Windows implementation of Python will be presented with more prominence than implementations in other operating systems.

In addition, the learning application may identify skills of the team members, and tailor the search to the skills of the members. For example, if the team members focus on developing applications for mobile devices, the learning application will take into consideration training results for applications on mobile devices.

Further, the learning application may detect that certain training modules may have already been consumed (e.g., seen) by some team members, so the learning application may recommend those training modules to other team members that have not consumed them, e.g., a recently added team member.

J The learning application may initiate a query based on a user input, as described above, or the learning application may generate recommendations automatically for the user. Further, the learning application may detect that a team is discussing a certain subject in the chat room, and the learning application may provide a recommendation of a particular training module to all the members involved in the discussion.

It is noted that the embodiments illustrated in FIG. 1 are examples and do not describe every possible embodiment. Other embodiments may utilize different layouts, additional fields or fewer fields, etc. The embodiments illustrated in FIG. 1 should therefore not be interpreted to be exclusive or limiting, but rather illustrative.

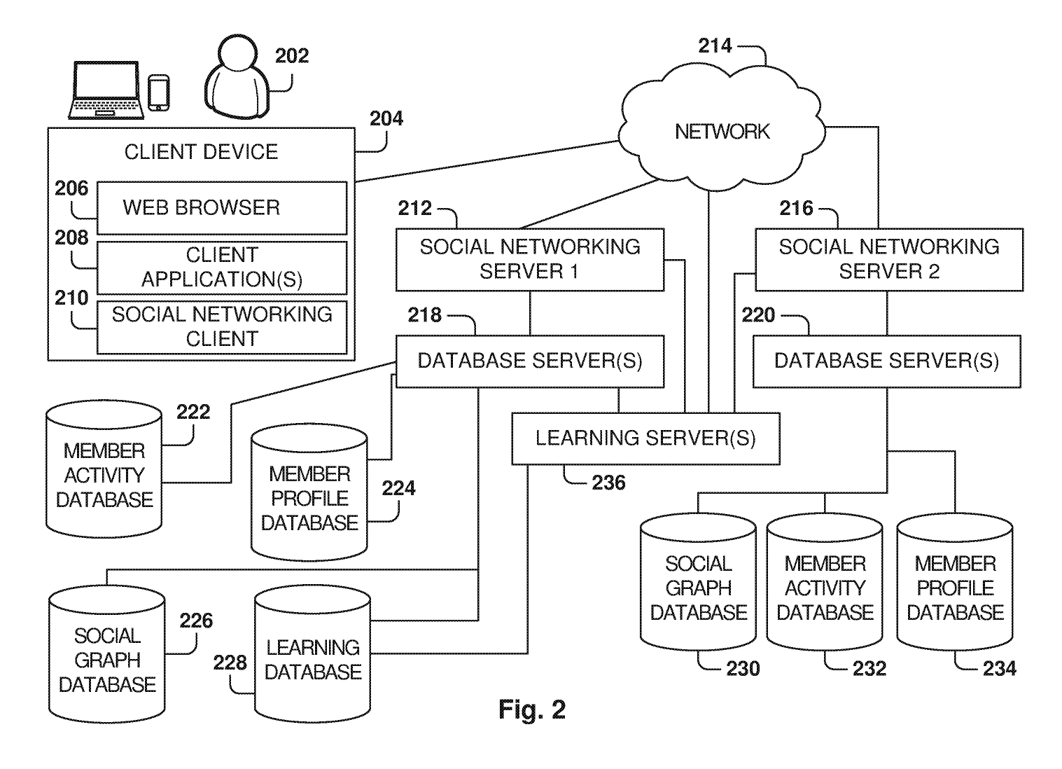

FIG. 2 is a block diagram illustrating a networked system, according to some example embodiments, illustrating an example embodiment of a high-level client-server-based network architecture. The social networking servers 212, 216 provide server-side functionality via a network 214 (e.g., the Internet or a wide area network (WAN)) to one or more client devices 204. FIG. 2 illustrates, for example, a web browser 206 (e.g., the Internet Explorer® browser developed by Microsoft® Corporation), client application(s) 208, and a social networking client 210 executing on a client device 204. The social networking server 212 is further communicatively coupled with one or more database servers 218 that provide access to one or more databases 222, 224, 226 and 228.

The client device 204 may comprise, but is not limited to, a mobile phone, a desktop computer, a laptop, a portable digital assistant (PDA), a smart phone, a tablet, an ultra book, a netbook, a multi-processor system, a microprocessor-based or programmable consumer electronic system, or any other communication device that a user 202 may utilize to access the social networking servers 212 and 216. In some embodiments, the client device 204 may comprise a display module (not shown) to display information (e.g., in the form of user interfaces).

In one embodiment, the social networking server 212 is a network-based appliance that responds to initialization requests or search queries from the client device 204. One or more users 202 may be a person, a machine, or other means of interacting with the client device 204.

The client device 204 may include one or more applications (also referred to as “apps”) such as, but not limited to, the web browser 206, the social networking client 210, and other client applications 208, such as a learning application, a messaging application, an electronic mail (email) application, a news application, and the like. In some embodiments, if the social networking client 210 is present in the client device 204, then the social networking client 210 is configured to locally provide the user interface for the application and to communicate with the social networking server 212, on an as-needed basis, for data and/or processing capabilities not locally available (e.g., to access a member profile, to authenticate a user 202, to identify or locate other connected members, etc.). Conversely, if the social networking client 210 is not included in the client device 204, the client device 204 may use the web browser 206 to access the social networking servers 212 and 216.

Further, while the client-server-based network architecture is described with reference to a client-server architecture, the present subject matter is of course not limited to such an architecture, and could equally well find application in a distributed, or peer-to-peer, architecture system, for example.

In one example embodiment, the social networking server 212 is communicatively coupled to a member activity database 222, a social graph database 226, a member profile database 224, and a learning database 228. The databases may be implemented as one or more types of databases including, but not limited to, a hierarchical database, a relational database, an object-oriented database, one or more flat files, or combinations thereof.

The member profile database 224 stores member profile information about members who have registered with the social networking server 212. With regard to the member profile database 224, the member may include an individual person or an organization, such as a company, a corporation, a nonprofit organization, an educational institution, or other such organizations.

Consistent with some example embodiments, when a user initially registers to become a member of the social networking service provided by the social networking server 212, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry (also referred to herein simply as industry), skills, professional organizations, and so on. This information is stored, for example, in the member profile database 224.

In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

As users interact with the social networking service provided by the social networking server 212, the social networking server 212 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 212), updating a current status, posting content for other members to view and comment on, job suggestions for the members, job-post searches, and other such interactions. In one embodiment, records of these interactions are stored in the member activity database 222, which associates interactions made by a member with his or her member profile stored in the member profile database 224. In one example embodiment, the member activity database 222 includes the posts created by the users of the social networking service for presentation on user feeds.

Members of the social networking service may establish connections with one or more members of the social networking service. The connections may be defined as a social graph, where the member is represented by a vertex in the social graph and the edges identify connections between vertices. Members are said to be first-degree connections where a single edge connects the vertices representing the members; otherwise, members are said to have connections of the n^{th} degree, where n is defined as the number of edges separating two vertices. In one embodiment, the social graph maintained by the social networking server 212 is stored in the social graph database 226.

Learning materials are stored in the learning database 228. In addition, other learning materials may be indexed and stored in other databases or somewhere on the network, and the learning servers 236 will index the data in the learning database 228 and other locations to make the training materials available to users.

Each training module may be analyzed to gather metadata, such as title, author, subject, tags associated with the subject, duration, type of media, creation date, user average score, recommendations, etc. After the training modules are analyzed, the training data is stored in the learning database 228. The learning servers 236 provide interfaces to the social networking servers 212, 216 and the client devices 204 to make the training modules available to users. For example, the learning server 236 may provide an API and a web interface for gaining access to the information in the learning database 228.

In one embodiment, the social networking server 212 communicates with the various databases through the one or more database servers 218. In this regard, the database servers 218 provide one or more interfaces and/or services for providing content to, modifying content in, removing content from, or otherwise interacting with the databases. For example, and without limitation, such interfaces and/or services may include one or more Application Programming Interface (APIs), one or more services provided via a Service-Oriented Architecture (SOA), one or more services provided via a REST-Oriented. Architecture (ROA), or combinations thereof.

The social networking server 216 is associated with a second social network that has similar functionality to the social networking server 212. For example, the social networking server 216 accesses database server 220 to access the corresponding social graph database 230, member activity database 232, and member profile database 234.

In some example embodiments, the information in the different social networks may be correlated. For example, the contacts or “friends” in one social network may be used in another social network to enhance the social graph by identifying users connected to a particular user in either network. Further, the information from the two social networks may be correlated to gather information about members of the team that the user is part of. As illustrated, two social networks are presented in FIG. 2, but the same principles may be utilized with more than two social networks.

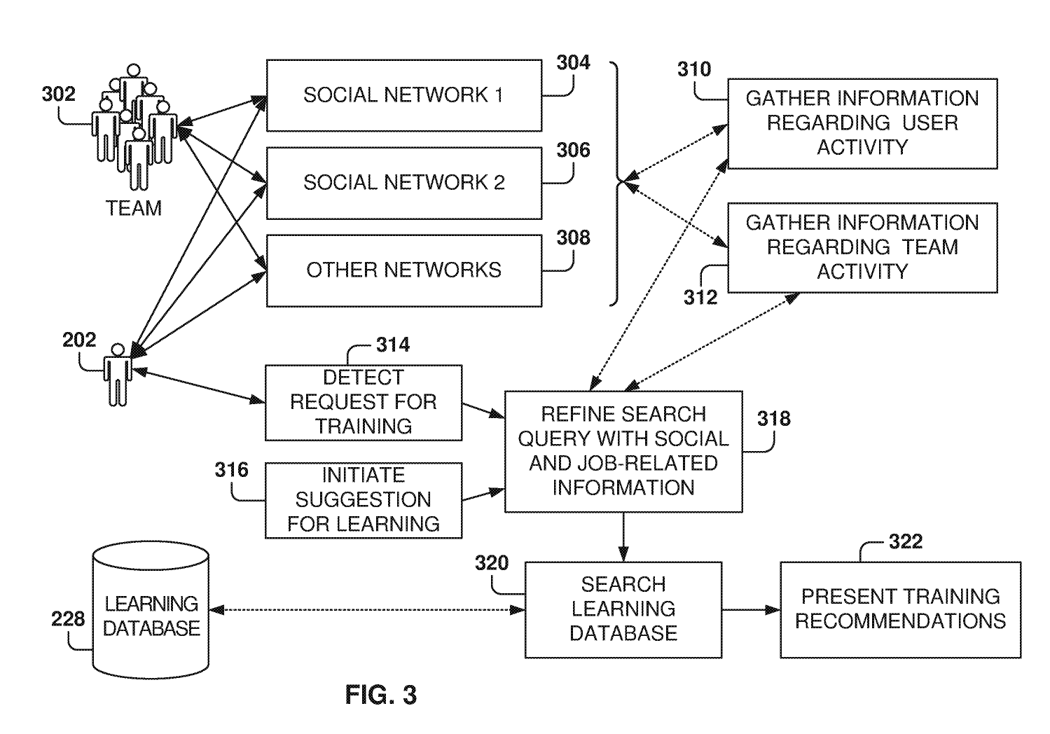

FIG. 3 illustrates a method for recommending training materials, according to some example embodiments. The best training recommendations are those that take into account not only the actual search query, but also the profile of the user and the profile of the team, as well as their activities. This way, the learning application is able to find and recommend training modules relevant to the user.

For example, if a software engineer wants to learn about machine learning, a search may be entered for “machine learning.” The system also analyzes the skills of the user, the experience of the user, the responsibilities of the user at work, the team activities, etc., to create an expanded query that takes into account not only “machine learning” but also the data associated with the user. The learning application may then recommend machine-learning training modules customized for the user, e.g., prioritized according to the needs of the software engineer.

The user 202 and the user's team 302 interact within one or more social networks, such as a first social network 304, second social network 306, and other networks 308. The team members may interact with one or more of the social networks. The social networks may be of different nature and have a different focus. For example, one social network may be geared towards work activities and team collaboration, while other networks may be geared towards professional relationships, friendship relationships, etc.

The learning application utilizes some of the interfaces provided by the social networks to provide the training offerings through one or more of the social networks. For example, the learning application may be integrated within a social network utilizing APIs, remote web access, or proprietary interfaces provided by the social network.

The learning system gathers information 310) regarding user activity, and gathers information (operation 312) regarding the activities of the team members. This also includes gathering profile information of the users in one or more of the social networks. For example, data regarding the user profile is gathered as well as the activities of the users in the social network in order to understand their interests and experience.

At operation 314, a request from the user 202 for training recommendations is detected. At operation 316, the learning system initiates a request for training suggestions. Thus, the request may be expressly originated by the user 202 entering a search query or the request may be initiated by the system to provide training suggestions to the user 202.

At operation 318, the search query (either expressly originated by the user 202 or created by the learning system based on user activity, such as the topic of the conversation in a chat room) is refined by expanding the search query with social and job-related information. Since the learning system is aware of the user's profile and activities, as well as the team's profile and activities, the search query is enhanced using this information, and the learning system is able to provide better recommendations that are relevant to the user's current needs. This means that the search query understands the context of the user 202 and the context of the team 302 to provide better recommendations.

This means that if two different users enter the same search query, but the two users have different contexts (e.g., different profile, different skills, different teams, etc.), the search query may return different results. For example, if a recent software engineer graduate asks for training on machine learning, and the same search is entered by a Chief Technical Officer (CTO) with many years of experience, the suggestions may differ. The recent graduate may be recommended entry-level courses while the CTO may receive recommendations on current trends and developments in the area of machine learning and artificial intelligence.

At operation 320, the learning system searches the learning database 228 for training modules based on the refined search query from operation 318, and at operation 322, the training recommendations are presented to the user 202.

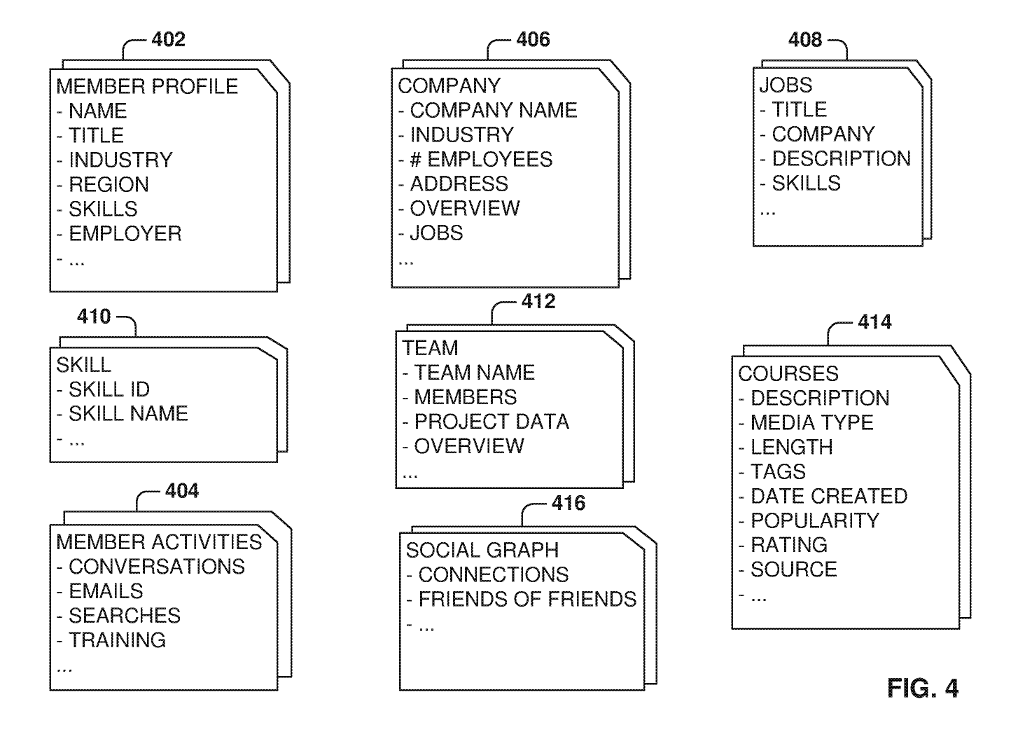

FIG. 4 illustrates data structures for storing user and team information, according to some example embodiments. The member profile 402 includes member information, such as name, title (e.g., job title), industry (e.g., legal services), geographic region, employer, skills and endorsements, and so forth. Within member profile 402, the skill information is linked to skill data 410, the employer information is linked to company data 406, the team information is linked to team data 412, social information is linked to social graph data 416, and other links to other data structures are present as needed. It is understood that the different data structures in FIG. 4 may be linked to each other, but the interconnections have been omitted for simplicity of description.

The skill data 410 is a table for storing the different skills identified in the social networks. In one example embodiment, the skill data 410 includes a skill identifier (ID) (e.g., a numerical value or a text string) and a name for the skill. The skill identifier may be linked to the member profiles 402 and job data 408.

The member activities data 404 includes information regarding activities of the members in the social networks and other environments, such as when web browsing. The member activities data 404 may include conversations of the user with other members, emails, searches requested, training modules consumed, etc.

In one example embodiment, the company data 406 includes company information, such as company name, industry associated with the company, number of employees, address, overview description of the company, job postings, and the like.

In some example embodiments, the team data 412 includes information about identified teams within one or more social networks. The team data 412 may include a team name, a team system identifier, list of members of the team, data about the project associated with the team, overview description of the team, team activities, etc.

The social graph data 416 includes information about connectivity of the members of the social networks, such as connections within each of the social networks, connections of connections (e.g., “friends of friends”), etc.

In one example embodiment, the job data 408 includes data for jobs posted by companies in the social network. The job data 408 includes one or more of a title associated with the job (e.g., software developer), a company that posted the job, a geographic region for the job, a description of the job, a type of job, qualifications required for the job, and one or more skills.

The courses data 414, also referred to as training modules, includes information about the courses in the training system. The training system gathers information about the different providers of training modules and indexes the data by identifying metadata associated with each of the training modules (e.g., name, type of media, author, length, date release, etc.) in order to make searching efficient and relevant.

The courses data 414 may include, for each of the training motives, a description, media type, a length or size, tags associated with the training module, the date created, the popularity of the training module (e.g., how many users have accessed the training module, reviews of the training module (e.g., as measured by results from surveys of users that have consumed the training module), the source of the training module, etc.

It is noted that the embodiments illustrated in FIG. 4 are examples and do not describe every possible embodiment. Other embodiments may utilize different data structures, fewer data structures, combine the information from two data structures into one, add additional or fewer links among the data structures, and the like. The embodiments illustrated in FIG. 4 should therefore not be interpreted to be exclusive or limiting, but rather illustrative.

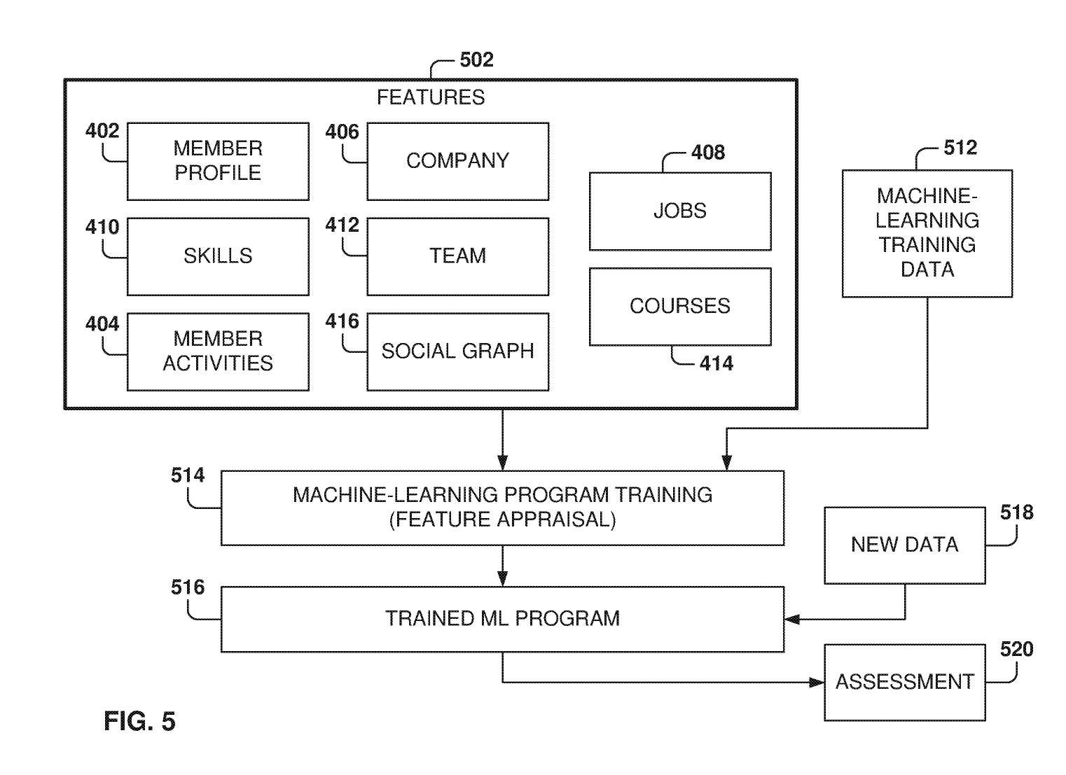

FIG. 5 illustrates the training and use of a machine-learning program 516, according to some example embodiments. In some example embodiments, machine-learning programs, also referred to as machine-learning algorithms or tools, are utilized to perform operations associated with generating training recommendations.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 512 in order to make data-driven predictions or decisions expressed as outputs or assessments 520. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for generating training recommendations.

In general, there are two types of problems in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a training module score (e.g., a number from 1 to 100) for ranking and selecting training modules to recommend in response to a query.

In one example embodiment, the features 502 may be of different types and may be associated with one or more of member profile 402, skill data 410, member activities data 404, company data 406, team data 412, social graph data 416, job data 408, and courses data 414, as described above with reference to FIG. 4. In some example embodiments, additional features may be included, such as post data, message data, web data, and the like.

The machine-learning algorithms utilize the training data 512 to find correlations among identified features 502 that affect the outcome. In some example embodiments, the training data 512 includes data related to the past use of the training modules by members of the social networks. For example, the training data includes the users that accessed a training module, the number of uses that have accessed a training module, the response of users to the training module, the recommendations of users for training modules, the popularity of the training modules, number of times a training module has been recommended, number of times that the training module has been selected, time spent on the training module, number of times the training module has been recommended to other users of the social networks, etc.

With the training data 512 and the identified features 502, the machine-learning tool is trained at operation 514. The machine-learning tool appraises the value of the features 502 as they correlate to the training data 512. The result of the training is the trained machine-learning program 516.

When the trained machine-learning program 516 is used to provide training recommendations, new data 518 is provided as an input to the trained machine-learning program 516, and the trained machine-learning program 516 generates the assessment 520 as output (e.g., recommendations). For example, when a member performs a search for training modules, the trained machine-learning program 516 uses the member profile 402 and team data 412 to search for training modules.

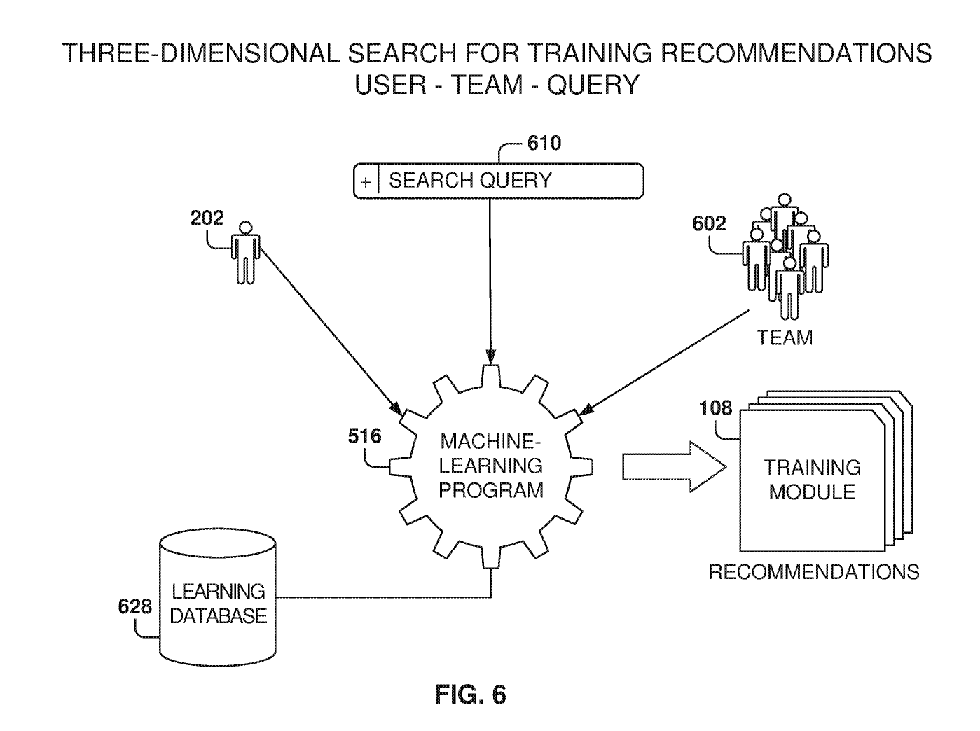

FIG. 6 illustrates the three-dimensional aspect of searching for training modules, according to some example embodiments. When identifying training modules for recommending to a user, the training system utilizes the trained machine learning program 516, which utilizes data in three dimensions: first, a user dimension with information related to the user 202; second, a search query dimension associated with the information entered on a search query 610 for training modules; and third, a team dimension with information related to the team 602.

The machine learning program 516 evaluates the data received on the three dimensions and searches the learning database 628 to generate recommendations for training modules. The search does not utilize only user data, or just search query data, but uses the three dimensions to form a context that scopes the search query for training recommendations. This way, the training recommendations would be better served because the machine learning program 516 takes into consideration the needs of the user 202, as framed by the user data, the search query 610, and the context provided by the team 602.

For example, a training recommendation may be accompanied with a message, “50% of the members of your team have already viewed these videos,” or “90% of the members of your team recommend this paper.” Further, the learning system may identify trends in the social network, either trends among the whole population, trends among people with similar skills and interests, trends among team members, etc. Based on the trends, the learning system may provide recommendations and notify the user about trending training materials. For example, the training system may send a message to the user, “in the last three days, 10 of your 15 team members have watched this video.” In some example embodiments, the training materials may also include news information, and training recommendations may be generated based on trending news.

The query results are customized because the machine-learning program 516 takes into consideration items such as popularity, ratings, etc., all customized to the user's background and in the context of team activities.

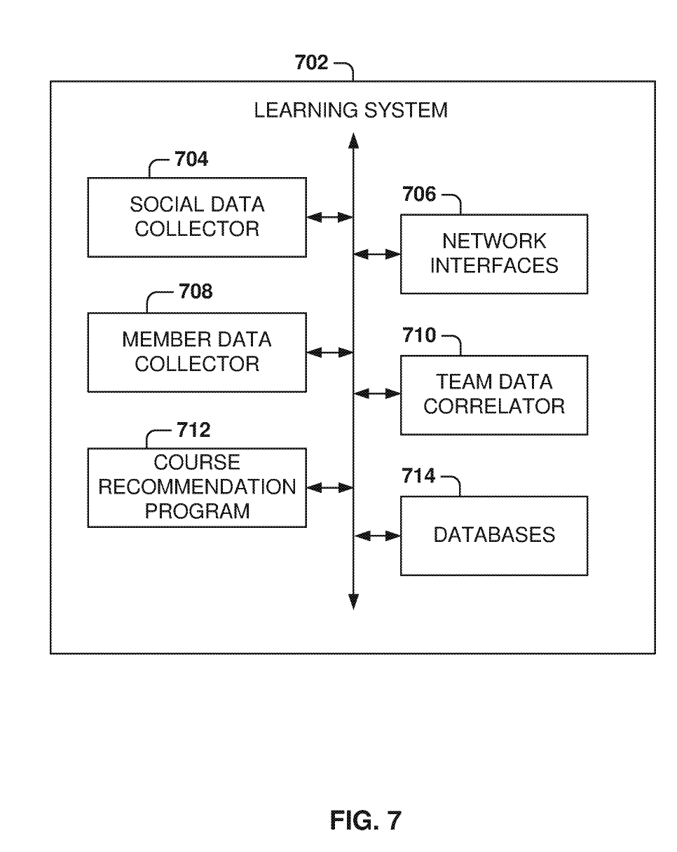

FIG. 7 is a simplified schematic diagram of a computer system for implementing embodiments described herein. In some example embodiments, the learning system 702 includes a plurality of modules: a social data collector 704, network interfaces 706, member data collector 708, team data correlator 710, course recommendation program 712, and databases 714.

Any one or more of the modules described herein may be implemented using hardware (e.g., a processor of a machine) or a combination of hardware and software. For example, a module may configure a processor to perform the operations described herein for that module. Moreover, any two or more of these modules may be combined into a single module, and the functions described herein for a single module may be subdivided among multiple modules. Furthermore, according to various example embodiments, the modules described herein as being implemented within a single machine, database, or device may be distributed across multiple machines, databases, or devices. In some example embodiments, some of the modules of the learning system 702 are computer programs executable by a computer processor, or the modules may be part of a computer program executing additional functions. Further, some of the modules may be storage devices, such as non-transitory machine-readable storage medium devices. The storage devices may store the instructions executed by the programs.

The social data collector 704 collects information from the social networks, such as user activities, team activities, team information, social graph of the users, etc. The network interfaces 706 provide network connectivity to other devices and programs.

The member data collector 708 gathers information about the user from one or more social networks, and if the user belongs to more than one social network, the information from the two or more social networks is correlated, such as to identify social connections of the user in either of the networks.

The team data correlator 710 correlates the user information for two different team members in order to assess team-related data, such as team activities, team purpose, team goals, etc.

The course recommendation program 712 generates training recommendations for the user. In some example embodiments, the course recommendation program 712 includes the machine learning program 516 for generating training recommendations.

In some example embodiments, the course recommendation program 712 may convert training modules from one format to another. For example, a video may be transcribed in order to provide the text to users who would rather read the training than watch the video. The other way is also possible, and a book or paper may be converted to speech and presented as an audible book.

In addition, the course recommendation program 712 may identify tags within the media, where the tags identify where certain subjects are covered. For example, a training module with several hours of video may be tagged to identify were different subjects are covered within the training module.

It is noted that the embodiments illustrated in FIG. 7 are examples and do not describe every possible embodiment. Other embodiments may utilize different modules, combine the functionality of two modules into one, utilize additional modules or fewer modules, distribute the functionality of any module across one or more servers, execute each of the modules in different servers, etc. The embodiments illustrated in FIG. 7 should therefore not be interpreted to be exclusive or limiting, but rather illustrative.

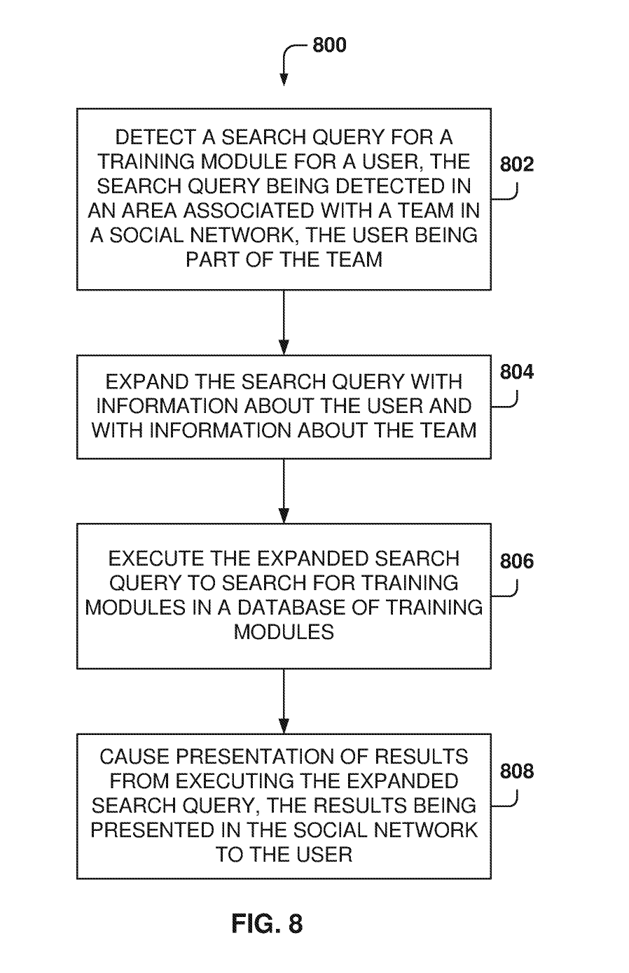

FIG. 8 is a flowchart of a method 800, according to some example embodiments, for searching a database of learning modules to provide recommendations based on user and team data. While the various operations in this flowchart are presented and described sequentially, one of ordinary skill will appreciate that some or all of the operations may be executed in a different order, be combined or omitted, or be executed in parallel.

At operation 802, one or more processors detect a search query for a training module for a user. The search query is detected in an area associated with a team in a social network (e.g., a team chat room), and the user is part of the team.

From operation 802, the method 800 flows to operation 804 for expanding, by the one or more processors, the search query with information about the user and with information about the team (e.g., see data illustrated in FIG. 4). From operation 804, the method 800 flows to operation 806, where the one or more processors execute the expanded search query to search for training modules in a database of training modules.

From operation 806, the method 800 flows to operation 808 where the one or more processors cause presentation of results from executing the expanded search query, the results being presented in the social network to the user (e.g., user interface 102 in FIG. 1).

In one example, the information about the user includes information in a profile of the user in the social network, information about activities of the user in the social network, and information about activities of the user associated with the team.

In one example, the information about the team includes team profile data, information in profiles of other team members, and information about activities of the other team members.

In another example, the method 800 further includes identifying features for a machine-learning program that executes the expanded search query, the features including a profile of the user in the social network, information about a company employing the user, information about the team, information about connections of the user, information about activities of the user and the team, and information about the training modules in the database of training modules.

In some examples, the machine-learning program is trained with information regarding user response to past recommendations, popularity of the training modules, profiles of members of the social network, activities of the members of the social network, and/or user recommendations regarding the training modules.

In one example, detecting the search query includes receiving an input via a command line interface, and performing natural language processing on the received input to generate the search query.

In one example, detecting the search query includes automatically initiating an operation to offer suggestions for training modules, and creating the search query in response to the initiating, the search query being created based on activities of the user in a chat room associated with the team.

In one example, the method 800 further includes tracking training modules being accessed by other team members, and tracking ratings and recommendations for the training modules entered by the other team members, where expanding the search query includes including the ratings and recommendations for the training modules entered by the other team members.

In another example, expanding the search query further comprises including the ratings and recommendations for the training modules entered by other members of the social network.

In one example, the area associated with the team includes one or more chat rooms, where the expanding the search query is further based on activities of team members in one or more of the chat rooms.

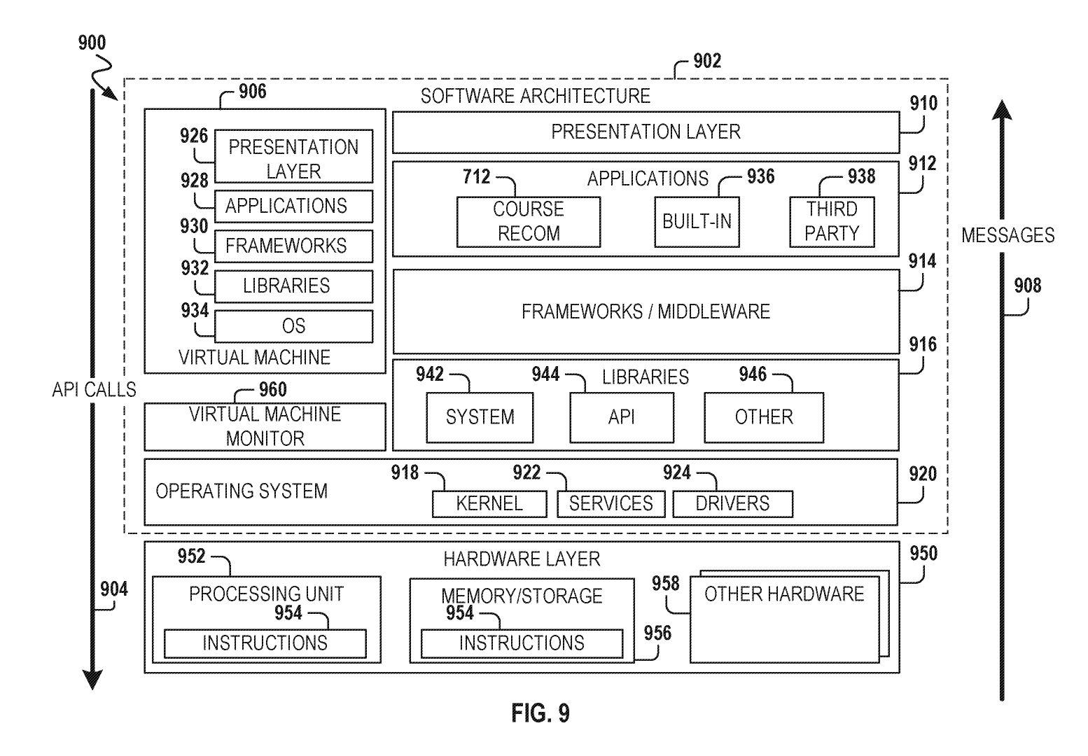

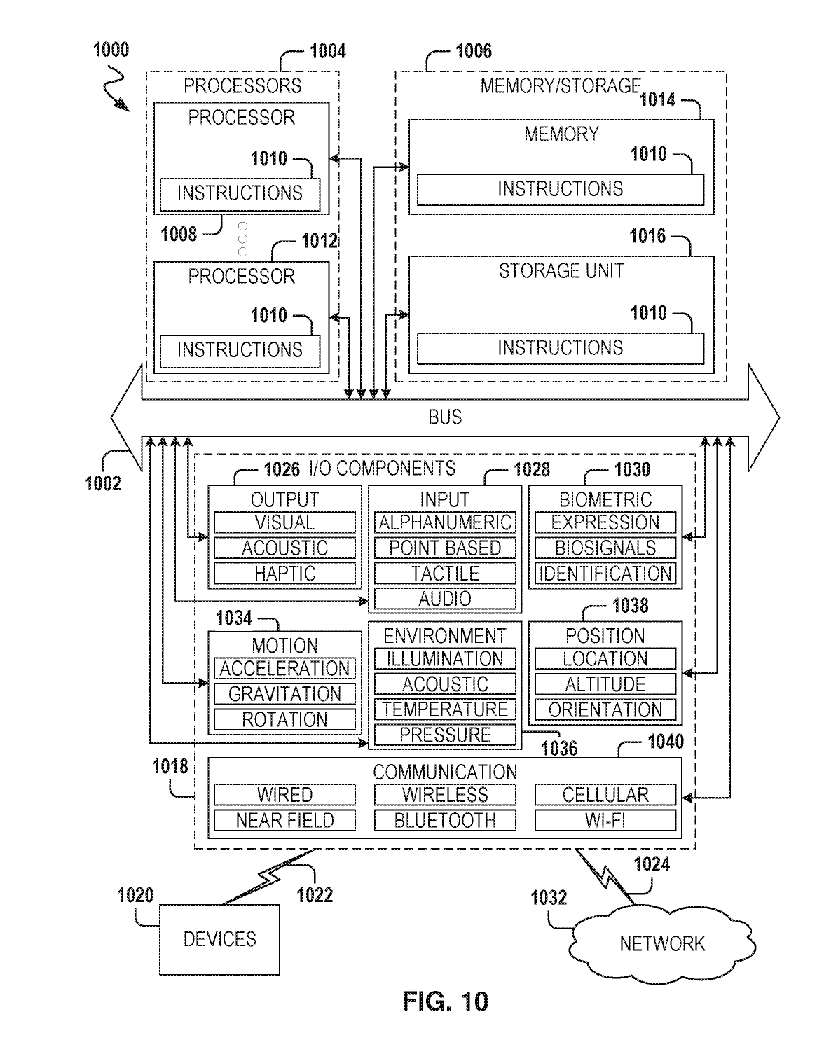

FIG. 9 is a block diagram 900 illustrating a representative software architecture 902, which may be used in conjunction with various hardware architectures herein described. FIG. 9 is merely a non-limiting example of a software architecture 902 and it will be appreciated that many other architectures may be implemented to facilitate the functionality described herein. The software architecture 902 may be executing on hardware such as a machine 1000 of FIG. 10 that includes, among other things, processors 1004, memory/storage 1006, and input/output (I/O) components 1018. A representative hardware layer 950 is illustrated and can represent, for example, the machine 1000 of FIG. 10. The representative hardware layer 950 comprises one or more processing units 952 having associated executable instructions 954. The executable instructions 954 represent the executable instructions of the software architecture 902, including implementation of the methods, modules and so forth of FIGS. 3, 5, 6, and 8. The hardware layer 950 also includes memory and/or storage modules 956, which also have the executable instructions 954. The hardware layer 950 may also comprise other hardware 958 which represents any other hardware of the hardware layer 950, such as the other hardware illustrated as part of the machine 1000.

In the example architecture of FIG. 9, the software architecture 902 may be conceptualized as a stack of layers where each layer provides particular functionality. For example, the software architecture 902 may include layers such as an operating system 920, libraries 916, frameworks/middleware 914, applications 912, and a presentation layer 910. Operationally, the applications 912 and/or other components within the layers may invoke application programming interface (API) calls 904 through the software stack and receive a response, returned values, and so forth illustrated as messages 908 in response to the API calls 904. The layers illustrated are representative in nature and not all software architectures have all layers. For example, some mobile or special purpose operating systems may not provide a frameworks/middleware layer 914, while others may provide such a layer. Other software architectures may include additional or different layers.

The operating system 920 may manage hardware resources and provide common services. The operating system 920 may include, for example, a kernel 918, services 922, and drivers 924. The kernel 918 may act as an abstraction layer between the hardware and the other software layers. For example, the kernel 918 may be responsible for memory management, processor management (e.g., scheduling), component management, networking, security settings, and so on. The services 922 may provide other common services for the other software layers. The drivers 924 may be responsible for controlling or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 912 and/or other components and/or layers. The libraries 916 typically provide functionality that allows other software modules to perform tasks in an easier fashion than to interface directly with the underlying operating system 920 functionality (e.g., kernel 918, services 922, and/or drivers 924). The libraries 916 may include system libraries 942 (e.g., C standard library) that may provide functions such as memory allocation functions, string manipulation functions, mathematic functions, and the like. In addition, the libraries 916 may include API libraries 944 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 916 may also include a wide variety of other libraries 946 to provide many other APIs to the applications 912 and other software components/modules.

The frameworks 914 (also sometimes referred to as middleware) may provide a higher-level common infrastructure that may be utilized by the applications 912 and/or other software components/modules. For example, the frameworks 914 may provide various graphic user interface (GUI) functions, high-level resource management, high-level location services, and so forth. The frameworks 914 may provide a broad spectrum of other APIs that may be utilized by the applications 912 and/or other software components/modules, some of which may be specific to a particular operating system or platform.

The applications 912 include course recommendation program 712, built-in applications 936, and/or third-party applications 938. Examples of representative built-in applications 936 may include, but are not limited to, a contacts application, a browser application, a book reader application, a location application, a media application, a messaging application, and/or a game application. The third-party applications 938 may include any of the built-in applications 936 as well as a broad assortment of other applications. In a specific example, the third-party application 938 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 938 may invoke the API calls 904 provided by the mobile operating system such as the operating system 920 to facilitate functionality described herein.

The applications 912 may utilize built-in operating system functions (e.g., kernel 918, services 922, and/or drivers 924), libraries (e.g., system libraries 942, API libraries 944, and other libraries 946), or frameworks/middleware 914 to create user interfaces to interact with users of the system. Alternatively, or additionally, in some systems, interactions with a user may occur through a presentation layer, such as the presentation layer 910. In these systems, the application/module “logic” can be separated from the aspects of the application/module that interact with a user.

Some software architectures utilize virtual machines. In the example of FIG. 9, this is illustrated by a virtual machine 906. A virtual machine creates a software environment where applications/modules can execute as if they were executing on a hardware machine (such as the machine 1000 of FIG. 10, for example). The virtual machine 906 is hosted by a host operating system (e.g., operating system 920 in FIG. 9) and typically, although not always, has a virtual machine monitor 960, which manages the operation of the virtual machine 906 as well as the interface with the host operating system (e.g., operating system 920). A software architecture executes within the virtual machine 906 such as an operating system 934, libraries 932, frameworks/middleware 930, applications 928, and/or a presentation layer 926. These layers of software architecture executing within the virtual machine 906 can be the same as corresponding layers previously described or may be different.

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1010 (e.g., software, a program, an application, an applet, an app, or other executable code) for causing the machine 1000 to perform any one or more of the methodologies discussed herein may be executed. For example, the instructions 1010 may cause the machine 1000 to execute the flow diagrams of FIGS. 3, 5, 6, and 8. Additionally, or alternatively, the instructions 1010 may implement the modules of FIGS. 2 and 7, and so forth. The instructions 1010 transform the general, non-programmed machine 1000 into a particular machine 1000 programmed to carry out the described and illustrated functions in the manner described.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1010, sequentially or otherwise, that specify actions to be taken by the machine 1000. Further, while only a single machine 1000 is illustrated, the term “machine” shall also be taken to include a collection of machines 1000 that individually or jointly execute the instructions 1010 to perform any one or more of the methodologies discussed herein.

The machine 1000 may include processors 1004, memory/storage 1006, and I/O components 1018, which may be configured to communicate with each other such as via a bus 1002. In an example embodiment, the processors 1004 (e.g., a Central Processing Unit (CPU), a Reduced instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1008 and a processor 1012 that may execute the instructions 1010. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single core, a single processor with multiple cores (e.g., a multi-core processor), multiple processors with a single core, multiple processors with multiples cores, or any combination thereof.

The memory/storage 1006 may include a memory 1014, such as a main memory, or other memory storage, and a storage unit 1016, both accessible to the processors 1004 such as via the bus 1002. The storage unit 1016 and memory 1014 store the instructions 1010 embodying any one or more of the methodologies or functions described herein. The instructions 1010 may also reside, completely or partially, within the memory 1014, within the storage unit 1016, within at least one of the processors 1004 (e.g., within the processor's cache memory), or any suitable combination thereof, during execution thereof by the machine 1000. Accordingly, the memory 1014, the storage unit 1016, and the memory of the processors 1004 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1010. The term “machine-readable medium” shall also be taken to include any medium, or combination of multiple media, that is capable of storing instructions (e.g., instructions 1010) for execution by a machine (e.g., machine 1000), such that the instructions, when executed by one or more processors of the machine (e.g., processors 1004), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1018 may include a wide variety of components to receive input, provide output, produce output, transmit information, exchange information, capture measurements, and so on. The specific I/O components 1018 that are included in a particular machine will depend on the type of machine. For example, portable machines such as mobile phones will likely include a touch input device or other such input mechanisms, while a headless server machine will likely not include such a touch input device. It will be appreciated that the I/O components 1018 may include many other components that are not shown in FIG. 10. The I/O components 1018 are grouped according to functionality merely for simplifying the following discussion, and the grouping is in no way limiting. In various example embodiments, the I/O components 1018 may include output components 1026 and input components 1028. The output components 1026 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1028 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1018 may include biometric components 1030, motion components 1034, environmental components 1036, or position components 1038 among a wide array of other components. For example, the biometric components 1030 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1038 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1018 may include communication components 1040 operable to couple the machine 1000 to a network 1032 or devices 1020 via a coupling 1024 and a coupling 1022, respectively. For example, the communication components 1040 may include a network interface component or other suitable device to interface with the network 1032. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1020 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geo-location, location via Wi-Fi® signal triangulation, location via detecting an NFC beacon signal that may indicate a particular location, and so forth.

In various example embodiments, one or more portions of the network 1032 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1032 or a portion of the network 1032 may include a wireless or cellular network and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1010 may be transmitted or received over the network 1032 using a transmission medium via a network interface device (e.g., a network interface component included in the communication components 1040) and utilizing any one of a number of well-known transfer protocols (e.g., hypertext transfer protocol (HTTP)). Similarly, the instructions 1010 may be transmitted or received using a transmission medium via the coupling 1022 (e.g., a peer-to-peer coupling) to the devices 1020. The term “transmission medium” shall be taken to include any intangible medium that is capable of storing, encoding, or carrying the instructions 1010 for execution by the machine 1000, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
detecting, by one or more processors, a search query for a training module for a user, the search query being detected in an area associated with a team in a social network, the user being part of the team;
expanding, by the one or more processors, the search query with information about the user and with information about the team;
executing, by the one or more processors, the expanded search query to search for training modules in a database of training modules; and
causing, by the one or more processors, presentation of results from executing the expanded search query, the results being presented in the social network to the user.

2. The method as recited in claim 1, wherein the information about the user comprises information in a profile of the user in the social network, information about activities of the user in the social network, and information about activities of the user associated with the team.

3. The method as recited in claim 1, wherein the information about the team comprises team profile data, information in profiles of other team a embers, and information about activities of the other team members.

4. The method as recited in claim 1, further comprising:
identifying features for a machine-learning program that executes the expanded search query, the features comprising a profile of the user in the social network, information about a company employing the user, information about the team, information about connections of the user, information about activities of the user and the team, and information about the training modules in the database of training modules.

5. The method as recited in claim 4, wherein the machine-learning program is trained with information regarding user response to past recommendations, popularity of the training modules, profiles of members of the social network, activities of the members of the social network, and user recommendations regarding the training modules.

6. The method as recited in claim 1, wherein detecting the search query comprises:
receiving an input via a command line interface; and
performing natural language processing on the received input to generate the search query.

7. The method as recited in claim 1, wherein detecting the search query comprises:
automatically initiating an operation to offer suggestions for training modules; and
creating the search query in response to the initiating, the search query being created based on activities of the user in a chat room associated with the team.

8. The method as recited in claim 1, further comprising:
tracking training modules being accessed by other team members; and
tracking ratings and recommendations for the training modules entered by the other team members, wherein expanding the search query comprises including the ratings and recommendations for the training modules entered by the other team members.

9. The method as recited in claim 8, wherein expanding the search query further comprises:
including the ratings and recommendations for the training modules entered by other members of the social network.

10. The method as recited in claim 1, wherein the area associated with the team comprises one or more chat rooms, wherein the expanding the search query is further based on activities of team members in one or more of the chat rooms.

11. A system comprising:
a memory comprising instructions; and
one or more computer processors, wherein the instructions, when executed by the one or more computer processors, cause the one or more computer processors to perform operations comprising:
detecting a search query for a training module for a user, the search query being detected in an area associated with a team in a social network, the user being part of the team;
expanding the search query with information about the user and with information about the team;
executing the expanded search query to search for training modules in a database of training modules; and
causing presentation of results from executing the expanded search query, the results being presented in the social network to the user.

12. The system as recited in claim 11, wherein the information about the user comprises information in a profile of the user in the social network, information about activities of the user in the social network, and information about activities of the user associated with the team.

13. The system as recited in claim 11, wherein the information about the team comprises team profile data, information in profiles of other team members, and information about activities of the other team members.

14. The system as recited in claim 11, wherein the instructions further cause the one or more computer processors to perform operations comprising:
identifying features for a machine-learning program that executes the expanded search query, the features comprising a profile of the user in the social network, information about a company employing the user, information about the team, information about connections of the user, information about activities of the user and the team, and information about the training modules in the database of training modules.

15. The system as recited in claim 14, wherein the machine-learning program is trained with information regarding user response to past recommendations, popularity of the training modules, profiles of members of the social network, activities of the members of the social network, and user recommendations regarding the training modules.

16. A non-transitory machine-readable storage medium including instructions that, when executed by a machine, cause the machine to perform operations comprising:
detecting a search query for a training module for a user, the search query being detected in an area associated with a team in a social network, the user being part of the team;
expanding the search query with information about the user and with information about the team;
executing the expanded search query to search for training modules in a database of training modules; and
causing presentation of results from executing the expanded search query, the results being presented in the social network to the user.

17. The machine-readable storage medium as recited in claim 16, wherein the information about the user comprises information in a profile of the user in the social network, information about activities of the user in the social network, and information about activities of the user associated with the team.

18. The machine-readable storage medium as recited in claim 16, wherein the information about the team comprises team profile data, information in profiles of other team members, and information about activities of the other team members.

19. The machine-readable storage medium as recited in claim 16, wherein the machine further performs operations comprising:
identifying features for a machine-learning program that executes the expanded search query, the features comprising a profile of the user in the social network, information about a company employing the user, information about the team, information about connections of the user, information about activities of the user and the team, and information about the training modules in the database of training modules.

20. The machine-readable storage medium as recited in claim 19, wherein the machine-learning program is trained with information regarding user response to past recommendations, popularity of the training modules, profiles of members of the social network, activities of the members of the social network, and user recommendations regarding the training modules.
